(19) United States
(12) Patent Application Publication
(10) Pub. No.: US 2015/0173315 A1
(43) Pub. Date: Jun. 25, 2015

(54) METHOD AND MODULAR STRUCTURE FOR CONTINUOUSLY GROWING AN AEROPONIC CROP

(71) Applicants: Carlos Aznar Vidal, (US); Alquimiza 12, S.L.U., Zaragoza (ES)

(72) Inventor: Carlos Aznar Vidal, Zaragoza (ES)

(21) Appl. No.: 14/383,438

(22) PCT Filed: Mar. 8, 2013
(86) PCT No.: PCT/ES2013/070150

§ 371 Date: Sep. 5, 2014

(30) Foreign Application Priority Data
Mar. 9, 2012 (ES) P 201230360
Mar. 1, 2013 (ES) P 201330299

(51) Int. Cl. A01G 31/02; A01G 1/00

(52) U.S. Cl. CPC A01G 31/02; A01G 1/001

(57) ABSTRACT

Procedure and modular structure for continuously growing an aeroponic crop, including the following phases: preparation of the seeding area, positioning on the line and germination; transfer and positioning on production bars; distribution by level and row, vegetative growth and maturing; irrigation and inspection; guiding, transport of production bars and harvesting; and cleaning and preparation of production bars and seed trays. These phases initially take place on the bottom floor and during maturing on one or more successive floors of a modular structure above the ground or beneath it.

### OBJECT OF THE INVENTION

Procedure and modular structure for continuously growing an aeroponic crop, characterised in that it comprises the following phases:
Phase involving the preparation of the seeding area, positioning on the line and germination.
Phase involving transfer and positioning on production bars.
Phase involving distribution by level and row, vegetative growth and maturing.
Phase involving irrigation and inspection.
Phase involving end of guiding, transport of production bars and harvesting.
Phase involving the cleaning and preparation of production bars and seed trays.

These phases initially take place on the bottom floor and during maturing on one or more successive floors of a modular structure positioned above the ground or beneath it.

It is an object of the invention to achieve a quality product in a sustainable manner by means of a facility provided with elements guaranteeing a large production capacity.

### BACKGROUND TO THE INVENTION

Soil-less crops are known at this moment in time and the best-known of them are hydroponic systems for their widespread use in the agricultural world as a means of maximising the use of the resources available to conventional agriculture. As is known, this is due to the fact that plants may grow and produce fruit in a nutrient solution, providing optimal results in terms of speed of growth and fruit yields, regardless of changes in the weather and seasonal variations, which do not affect crops of this type, which can be grown in thermally controlled environments, but with the drawback that these systems do not provide the roots with good aeration.

In these types of crops, nutrients may be supplied in a closed circuit, with the plants being totally insulated from the surrounding environment, which allows maximum use to be made of water and results in the absence of pests and disease, as the possibility of infection from the exterior is reduced, with the drawback that they are usually grown on a single floor, the result being that the production area and its insulation is very small.

Another drawback to take into consideration is that most of these types of farms are located in agricultural areas that are a long distance from cities and towns, which results in a series of costs added to the product, such as transport and distribution.

As an example of hydroponic crop procedures, the patents JP2003339258 and JP2004065265 present two hydroponic crop systems developed with totally automated systems, but with the drawback of being developed on one production level only.

### DESCRIPTION OF THE INVENTION

In order to make more use of the production space and intensify the production of crops, a procedure and modular structure for continuously growing an aeroponic crop—the object of the present invention and characterised in that it comprises the following phases—has been designed:
Phase involving the preparation of the seeding area, positioning on the line and germination,
Phase involving transfer and positioning on production bars,
Phase involving distribution by level and row, vegetative growth and maturing,
Phase involving irrigation and inspection,
Phase involving end of guiding, transport of production bars and harvesting,
Phase involving the cleaning and preparation of production bars and seed trays,

These phases initially take place on the bottom floor and during maturing on one or more successive floors of a modular structure that may be positioned above the ground or beneath it, enabling the intensive use of the ground, by planting a crop on various levels, making maximum use of the area available, due to the fact that it can be located on any type of ground, thus allowing maximum use to be made of it for crop production and the optimising of resources.

Aeroponics is a crop-growing system that offers a major advantage over conventional hydroponic systems in that it allows excellent aeration of the roots. This is reflected by the fact that the amount of oxygen dissolved in water is measured in mg/L, or parts per million (ppm), this amount being 5-10 mg/L at 20° C., while the amount of oxygen dissolved in the air is measured as a percentage (21%), which tells us that the concentration of oxygen in the air is in the region of 20,000 times higher than the concentration of the same gas dissolved in water.

Phase Involving the Preparation of the Seeding Area, Positioning on the Line and Germination:

The seeds and the processed inorganic substrate, such as mineral wool, coconut fibre, etc, stored in specific climatic conditions, are collected and placed in a planting area, with, first of all, the substrate and then the seeds being deposited in the corresponding cavities of the seed trays, and the first irrigation being conducted, with the growing units being created as a result.

They are then positioned in the seedbed area, planted as a continuous line, and advance at a rate of one position a day, in accordance with their width dimensions, with the necessary days being allowed for the germination and development of the growing units, with plants being obtained every day at the end of the germination cycle, while the growing units increase in number in order to make up for defects in certain specimens that do not complete the germination and growth process satisfactorily.

Phase Involving Transfer and Positioning on Production Bars:

The growing units are removed from the seed trays and repositioned in the internal cavity of a support designed to be positioned on the production bars for their subsequent development.

The support has its position fixed on the production bars by means of a pipe section, which also allows the irrigation water to leach.

Once the support has been fixed in position on the production bar, a funnel is positioned on it to ensure that all the irrigation water is used, with the crop then being transferred all along the modular structure, without the need for the plants to be trained, with the result that once the growing units have been loaded on the production bars, they are placed by means of a hoist one by one at the start of the line in a waiting area, moving forward by gravity by one position per day until they are positioned with a lifting/lowering system.

As they develop, the growing units, which are positioned vertically, extend beyond the height of the support and continue to grow downwards, as the strength of the root system enables this.

Phase Involving Distribution by Level and Row, Vegetative Growth and Maturing

Each of the production bars located in the waiting area is transported by means of a lifting/lowering system, through an auger or a commercial stacker crane, located at each end of the modular structure, with the growing units continuing in their development, flowering and maturing of the fruit, the production bars advancing as a result of gravity by means of the rail system, at a rate of one position per day, along the entire length of the modular structure, during the days for which the process lasts.

Phase Involving Irrigation and Inspection:

The irrigation of the growing units positioned on their respective supports inserted on the production bars is automatically controlled throughout the modular structure by means of an irrigation controller, with a moisture controller being optionally included at various points for its control.

During the irrigation of the growing units, the leaching of the irrigation water is channelled through the pipe sections of the supports, running from the production bars to a channel built into the modular structure, carrying the water for its re-use.

The process in this phase involves the continuous inspection and checking of the development of the growing units through inspection platforms, built into a latticework structure that, operated electronically, passes with a moving motion along the modular structure, through aisles formed on both sides, the inspection platforms being capable of unfolding in order to allow the operator to access the growing units furthest from the aisle and inspect them.

Phase Involving End of Guiding, Transport of Production Bars and Harvesting:

When the cycle has been completed, the production bars corresponding to daily production reach the end of the guides and are moved to the bottom floor by the lifting/lowering system one by one and are positioned in the picking area in the order given by said process, with various tasks then being carried out: continuous inspection, selection and picking of the fruit, which is deposited once it is picked in a channel of water for washing, with the result that as the fruit floats on the water, it cannot bump against each other, thus remaining undamaged, with the selected fruit then being positioned so that it can be dried, processed, packaged, stored and dispatched.

Finally, the waste is cleared and removed, being deposited in suitable containers in order to be dried and then processed in a grinder unit.

Phase Involving the Cleaning and Preparation of Production Bars and Seed Trays:

Once the fruit has been unloaded during harvesting, the supports of the production bars are stacked and transported in trolleys to a washing area of the modular structure, with the seed trays, after being emptied, also being taken to the same washing area, and the production bars also being transported to the same washing area, on rails through a transit area.

Modular Structure:

The modular structure for continuously growing an aeroponic crop is characterised in that it comprises structural elements positioned horizontally and vertically, forming a bottom floor and one or more successive floors, incorporating two aisles, one being located on the right side between rows one and two, and the other on the left side between rows three and four, with the two central rows—two and three—being connected, there being housed in each aisle a latticework structure, conducted on a guide system inserted into the modular structure itself.

The horizontal structural elements are disposed on the modular structure at a slight angle in order to facilitate the movement by gravity of the production bars, on a rail system inserted in the structure, with the irrigation system moving on the sides of the production bars by means of a track system.

The latticework structure comprises two columns that house between them an inspection platform, which moves with ascending and descending vertical movements in order to enable the inspection of the status of the growing units, located on any of the floors comprised in the modular structure.

The inspection platform is disposed in its lower part with two surfaces of similar dimensions, which may be opened out from right to left to allow the operator to access the growing units furthest from the side aisles.

The irrigation system is made up of a support composed of a water pipe with a plurality of irrigation nozzles for the solution of water and nutrients, incorporating at its ends a track system that is automatically operated, so that it may be guided on the ends of the production bars.

The irrigation system provides a solution of water and nutrients in a completely automatic manner, especially adapted to the plant's maturing cycles, both in terms of the amount of each nutrient and in the physical properties of the solution.

The production bars are made up of two side sections disposed at both ends with a rolling system, being connected to each other by two transverse pipes separated from each other and centred at an equidistant distance, disposed with cavities designed for the insertion of the corresponding supports, which fix their position by means of a pipe section, which as well as fixing their position allows the leaching of the irrigation water, with the transverse pipes incorporating an internal channel designed to collect the water from the leaching and channel it for its re-use towards a channel positioned on the modular structure.

The support is made up of an internal cavity designed to house the growing unit and of two side extensions located in its lower part, designed to ensure its positioning on the transverse pipes.

The length dimensions of the production bars coincide with the dimensions between the vertical structural elements of the modular structure, and the width dimensions are configured to coincide with their daily advance during the procedure, corresponding to the maturing time.

The bottom floor comprises a planting area, seedbed area, waiting area, picking and dispatch area, a washing, drying and packaging area, an area for washing the production bars, their corresponding supports and seed trays and a trolley transit area, which are delimited for the development of the procedure being claimed, with successive levels being reserved for the crop-maturing procedure and for points of access for services, storage, loading and unloading of supplies, dispatch of the fruit and the entry/exit of personnel.

The planting area and the seedbed area are comprised, and connected to each other by means of an assembly line positioned on a bench placed at a slight angle for the sliding by gravity, of the seed trays, which are made up of a perforated plate provided with a plurality of cavities and incorporating in their rear part a drainage outlet for the removal of the excess irrigation water.

The width dimensions of the seed trays are configured in order to coincide with the daily advance, which coincides with the germination time.

The waiting area comprises a continuous line with rails, configured at a slight angle, positioned above the planting area and seedbed area, designed for the accumulation as a result of gravity of the production bars waiting to be transported to the successive production floors.

The picking area is positioned in parallel with the area for washing, drying and packaging the fruit, which comprises a water channel, a drying section and a final section for packaging, positioned in a continuous manner on an automatic assembly line.

The area for washing supports and seed trays collected in trolleys and production bars on rails comprises an automatic water sprinkler system for their maintenance, cleaning and sterilisation, which keeps them in perfect conditions of hygiene for their incorporation at the start of the procedure.

The dispatch area comprises various assembly lines designed to transport the packaged fruit to the fork-lift trucks or pallet trucks for their subsequent loading and grouping in distribution vehicles.

There are different storage areas: a climate-controlled store for the seeds, another for storing raw materials and a storage area for packaged fruit that is ready to be distributed.

The service areas are areas set aside for the maintenance of the facility, the offices and the laboratory.

The grinder unit is a machine located externally, close to the biomass and boiler area, designed to grind discarded waste, which is kept in containers until it is dried, and is stored once it has been ground, in a biomass tank to supply the boiler.

### Advantages of the Invention

The procedure and modular structure for continuously growing an aeroponic crop, which is presented herein, provides a number of advantages in comparison to the procedures that are currently available, the most important of them being the intensification of the use of the ground, with the proposed development of an aeroponic crop procedure on various levels allowing its growth downwards, thereby avoiding the need to train the fruit and making maximum use of the area available, it being capable of being located on any type of ground, its use being rationalised for agricultural production and the optimisation of resources, with the creation of a quality product in a sustainable manner.

Another important advantage is that the modular structure comprises structural elements positioned horizontally and vertically, with the horizontal elements presenting a slight angle in order to enable the movement by gravity of the production bars by means of a rail system, thus allowing continuous production.

Another important advantage is that the modular structure incorporates two aisles, one located on the right side and the other on the left side, designed for the transit, by means of tracks, of a latticework structure that incorporates inspection platforms.

It should be added that another important advantage is that the implementation of the movement by gravity of most of the different elements included in the procedure significantly reduces the mechanisation of the procedure's facility, leading to very significant energy savings.

Another of the most important advantages is that the bottom floor comprises a planting area, seedbed area, waiting area, picking area, trolley transit area, area for washing the production bars and seed trays, a washing, drying and packaging area and a dispatch area, which are delimited for the development of the procedure being claimed, with successive levels being reserved for the procedure of the downward maturing of the crop and for points of access for services, storage, loading and unloading of supplies, dispatch of the fruit and the entry/exit of personnel

As an important advantage it should be added that the seed trays, located in the seedbed area, are made up of a perforated plate, provided with a plurality of cavities and incorporating in their rear part a drainage outlet for the removal of the excess irrigation water.

Another important advantage that should be pointed out is that both the production bars and the seed trays are configured in terms of their width with dimensions that coincide with their daily advance, which is related to the number of days needed for the fruit to ripen.

As an important advantage it should be pointed out that the production bars are made up of two side sections disposed at both ends with a rolling system, being connected to each other by two transverse pipes separated from each other and centred at an equidistant distance, disposed with cavities designed for the insertion of supports, fixed to it by means of a pipe section.

Finally, a further advantage is that the support of the production bars is designed to house the production units throughout the entire production process.

### DESCRIPTION OF THE FIGURES

To provide a better understanding of the object of the present invention, a preferred practical embodiment of said invention is shown in the drawings attached.

In said drawings FIG. 1 shows a schematic view of the different phases comprised in the procedure for continuously growing an aeroponic crop, with A corresponding to the phase involving the preparation of the seeding area, positioning on the line and germination, B to the phase involving transfer and positioning on production bars, C to the phase involving distribution by level and row, vegetative growth and maturing, D to the phase involving irrigation and inspection, E to the phase involving end of guiding, transport of production bars and harvesting, and F to the phase involving the cleaning and preparation of production bars and seed trays

FIG. 2 shows an elevated view of the modular structure for continuously growing an aeroponic crop, above the ground, showing the inspection platform included in a latticework structure.

FIG. 3 shows a view of the bottom floor, showing the different areas and devices included in it.

FIG. 4 shows a detail of the seedbed and planting area, showing how the seed trays are handled.

FIG. 5 shows a plan view and profile view of the seedbed tray.

FIG. 6 shows a plan view of one of the levels of the modular structure, showing the space set aside for the production bars containing growing units and the two side aisles set up to allow the movements of the latticework structure.

FIG. 7 shows a detail of the assembly of the irrigation system and production bars on the rail system of the modular structure, showing the guiding of the irrigation system on the sides of the production bar and the leaching of the irrigation water.

FIG. 8 shows a plan view of a production bar.

FIG. 9 shows a plan view of production bar with the supports incorporated.

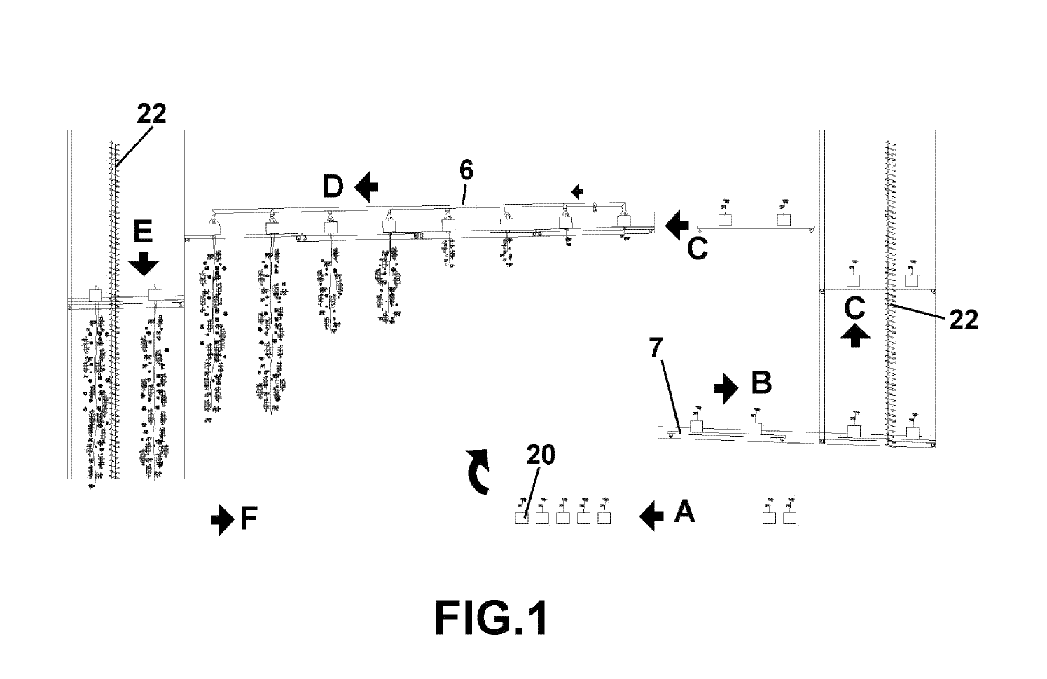

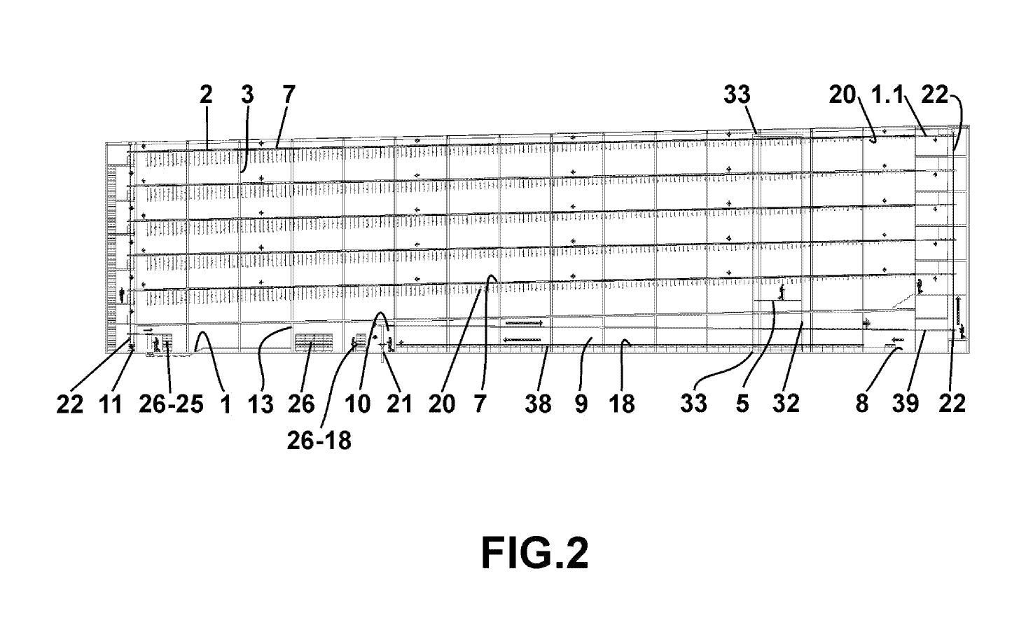

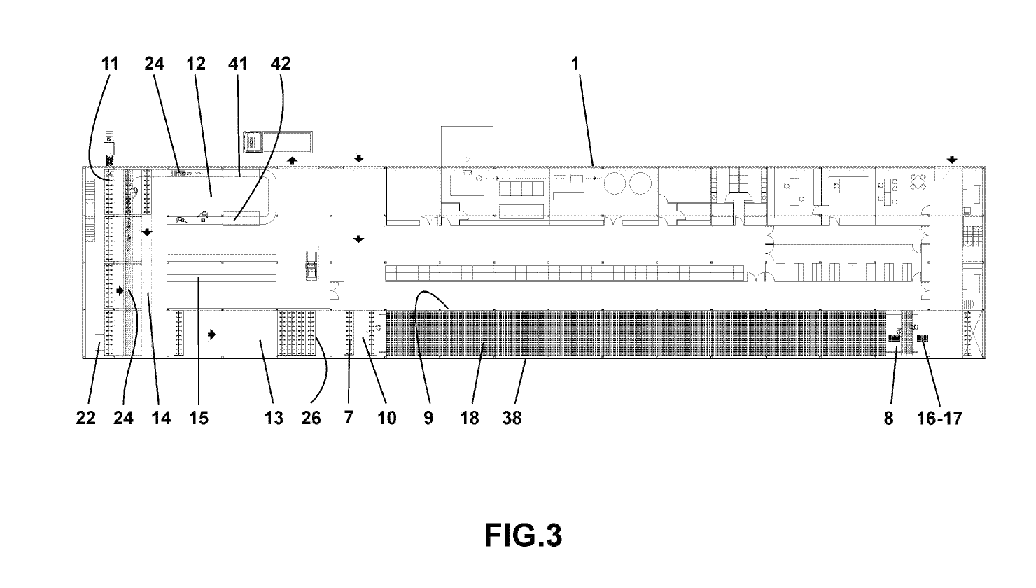

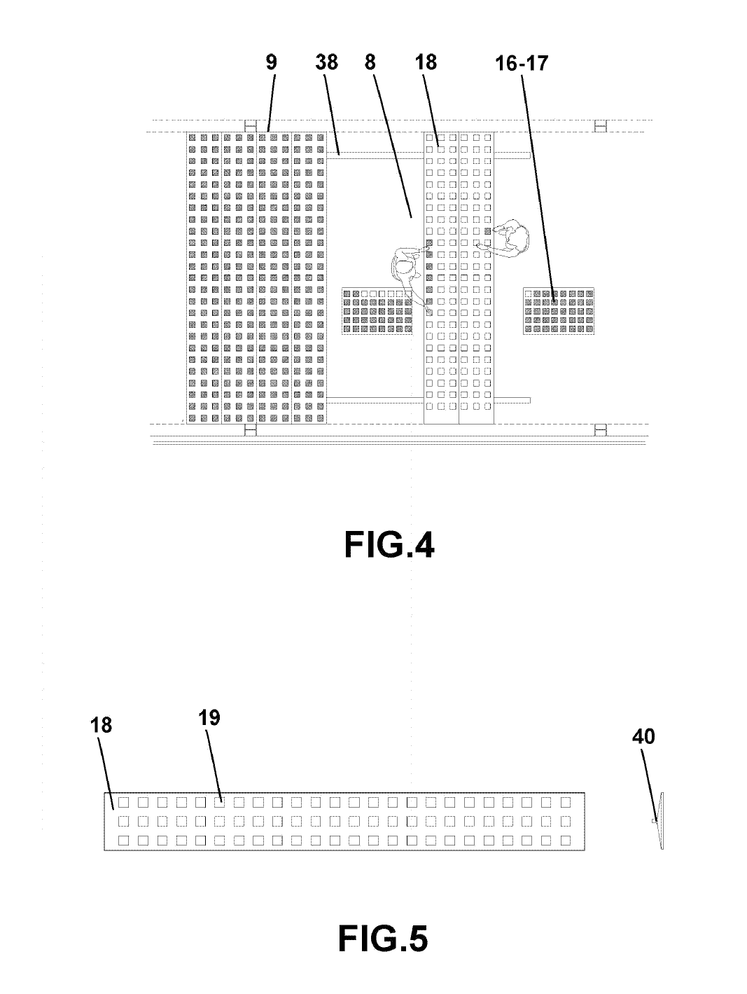

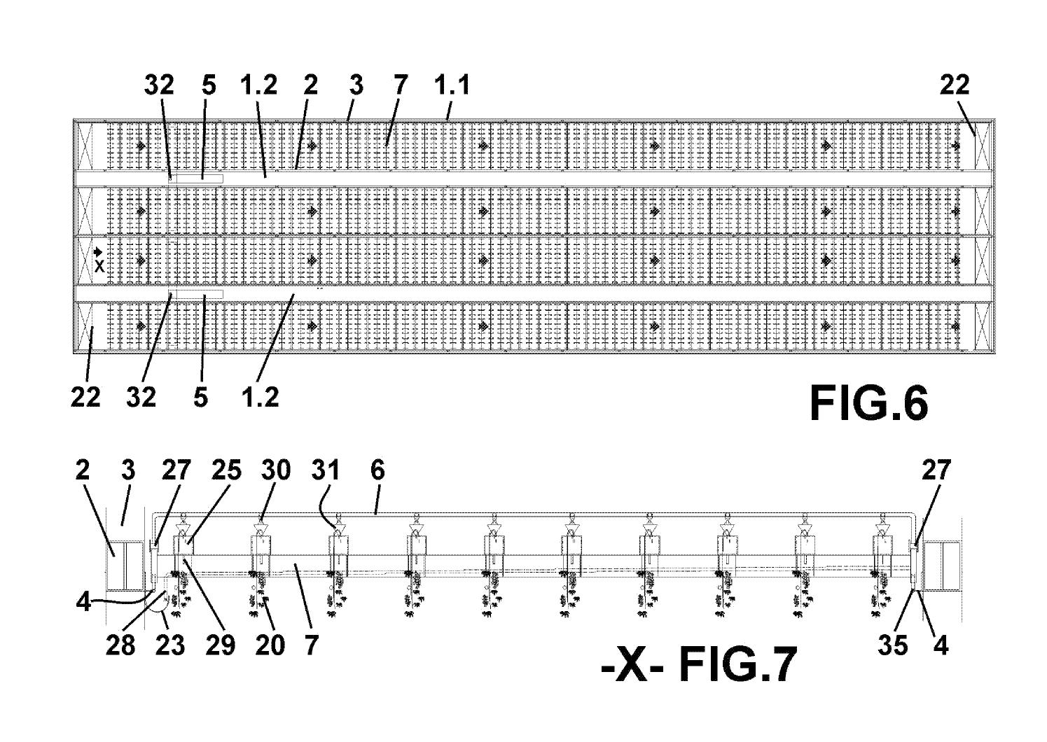

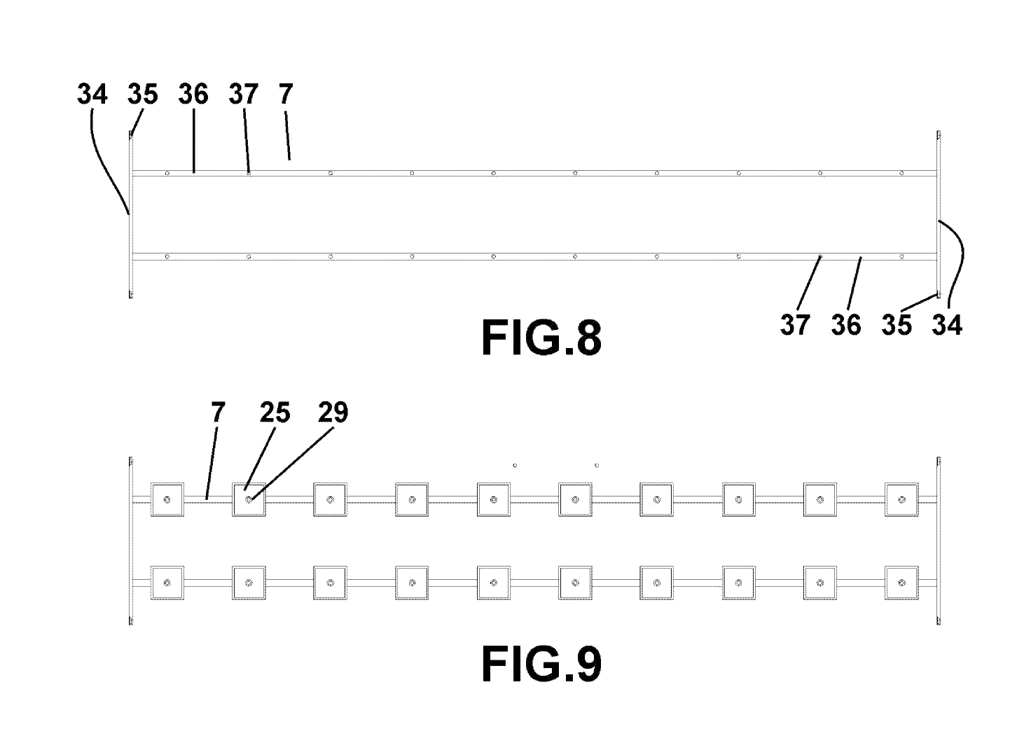

### PREFERRED EMBODIMENT OF THE INVENTION

The continuous aeroponic crop procedure, which is presented herein, is characterised in that it comprises the following phases:
Phase involving the preparation of the seeding area, positioning on the line and germination.
Phase involving transfer and positioning on production bars.
Phase involving distribution by level and row, vegetative growth and maturing.
Phase involving irrigation and inspection.
Phase involving guiding, transport of production bars and harvesting.
Phase involving the cleaning and preparation of production bars and seed trays.

These phases initially take place on the bottom floor (1) and during maturing on one or more successive floors (1.1) of a modular structure above the ground or beneath it.

Phase Involving the Preparation of the Seeding Area, Positioning on the Line and Germination:

The seeds (16) and the substrate (17) are transported and placed in a planting area (8), with, first of all, the substrate (17) and then the seeds (16) being deposited in the corresponding cavities of the seed trays (18), the first irrigation being conducted, with the growing units (20) being created as a result, and the seed trays (18) then being positioned in a seedbed area (9), planted as a continuous line, with their advance, by gravity, corresponding to one position per day, in accordance with their width dimensions, with the necessary days being allowed for the germination and development of the growing units (20), with plants being obtained every day at the end of the germination cycle, while the growing units (20) increase in number in order to make up for defects in certain specimens that do not complete the germination and growth process satisfactorily.

Phase Involving Transfer and Positioning on Production Bars:

The growing units (20) are removed from the seed trays (18) and repositioned in the internal cavity of a support (25) designed to be positioned on the production bars (7) for their subsequent development, their position being fixed on the production bars (7) by means of a pipe section (29), which also allows the irrigation water to leach, with, once the support (25) has been fixed in position on the production bar (7), a funnel (31) being positioned on it and being intended to ensure that all the irrigation water is used, with the crop then being transferred all along the modular structure, without the need for the plants to be trained, with the result that once the growing units (20) have been loaded on the production bars (7) they are placed by means of a lift (21) one by one at the start of the line, in a waiting area (10), moving forward by gravity by one position per day until they are positioned with a lifting/lowering system (22).

As they develop, the growing units (20), which are positioned vertically, extend beyond the height of the support (25) and continue to grow downwards, as the strength of the root system enables this.

Phase Involving Distribution by Level and Row, Vegetative Growth and Maturing:

Each of the production bars (7) located in the waiting area (10) advances by gravity by one position per day, until being positioned with a lifting/lowering system (22), auger or commercial stacker crane, located at each end of the modular structure, for their transport to the corresponding successive floor (1.1), with the production bars (7) being positioned until daily production is completed, the growing units (20) continuing in their development, flowering and maturing of the fruit, with the production bars (7) advancing by means of the rail system (4), at a rate of one position per day, along the entire length of the modular structure, during the days for which this process lasts.

Phase Involving Irrigation and Inspection:

Irrigation is carried out automatically by means of an irrigation controller, with a moisture controller being optionally included at various points of the modular structure for its control, with the leaching of the irrigation water of the growing units (20) being channelled from the production bars (7), through the pipe sections (29) of the supports (25) and its own internal pipes, towards a channel (23) incorporated in the modular structure, carrying the water for its re-use, with the production process being checked by means of a latticework structure (32) with an inspection platform (5) that, operated electronically, passes with a moving motion along the modular structure through aisles (1.2) formed on both sides so that the operator can inspect the status of the growing units (20).

Phase Involving End of Guiding, Transport of Production Bars and Harvesting:

When the cycle has been completed, the production bars (7) corresponding to daily production reach the end of the guides and are moved to the bottom floor (1) by the lifting/lowering system (22) one by one and are positioned in the picking and dispatch area (11) in the order given by said process, with various tasks then being carried out: continuous inspection, selection and picking of the fruit, which is deposited once it is picked in a channel of water (24) in the washing, drying and packaging area (12), with the selected fruit then being positioned so that it can be dried, processed, packaged, stored and dispatched.

The waste is cleared and removed, being deposited in suitable containers in order to be dried and then processed in a grinder unit.

Phase Involving the Cleaning and Preparation of Production Bars and Seed Trays:

Once the fruit has been unloaded during harvesting, the supports (25) of the production bars (7) are stacked and transported in trolleys (26) to a washing area (13), as are the seed trays (18) after being emptied, with the production bars (7) being transported to the same washing area (13), guided on rails through a transit area.

Modular Structure:

The modular structure for continuously growing an aeroponic crop is characterised in that it comprises structural elements positioned horizontally (2) and vertically (3), forming a bottom floor (1) and one or more successive floors (1.1), with the horizontal structural elements (2) presenting a slight angle to facilitate continuous production by gravity, on a rail system (4), designed to guide the production bars (7).

The modular structure incorporates two aisles (1.2), one being located on the right side between rows one and two, and the other on the left side between rows three and four, with the two central rows—two and three—being connected, there being housed in each aisle a latticework structure (32), conducted on a guide system (33) inserted into the modular structure itself.

The latticework structure (32) comprises two columns that house between them an inspection platform (5), which moves with ascending and descending vertical movements in order to enable the inspection of the status of the growing units, located on any of the successive floors (1.1) comprised in the modular structure.

The inspection platform (5) is disposed in its lower part with two surfaces of similar dimensions, which may be opened out from right to left to allow the operator to access the growing units furthest from the aisles (1.2).

The irrigation system is made up of a support composed of a water pipe with a plurality of irrigation nozzles (30) for the solution of water and nutrients, incorporating at its ends a track system (27) that is automatically operated so that it may be guided on the ends of the production bars (7).

The production bars (7) are made up of two side sections (34) disposed at both ends with a rolling system (35), being connected to each other by two transverse pipes (36) separated from each other and centred at an equidistant distance, disposed with cavities (37) designed for the insertion of supports (25), which fix their position by means of a pipe section (29), which as well as fixing their position allows the leaching of the irrigation water, with the transverse pipes (36) incorporating an internal channel (28) designed to collect the water from the leaching and channel it for its re-use towards a channel (23) positioned on the modular structure.

The support (25) is made up of an internal cavity designed to house the growing unit and of two side extensions located in its lower part, designed to ensure their positioning on the transverse pipes (36).

The length dimensions of the production bars (7) coincide with the dimensions between the vertical structural elements (3) of the modular structure, and the width dimensions are configured to coincide with their daily advance during the procedure, corresponding to the maturing time.

The bottom floor (1) comprises a planting area (8), seedbed area (9), waiting area (10), picking and dispatch area (11), a washing, drying and packaging area (12), a washing area (13) for the production bars (7) and seed trays (18), and a trolley transit area (14), which are delimited for the development of the procedure.

The planting area (8) and seedbed area (9) are comprised, and connected to each other by means of an assembly line (38) positioned on a bench that moves forward by the action of gravity, of seed trays (18), which are made up of a perforated plate provided with a plurality of cavities (19), and incorporating in their rear part a drainage outlet (40) for the removal of the excess irrigation water, its width dimensions corresponding with the daily advance coinciding with the germination time.

The waiting area (10) comprises a continuous line (39) with rails, configured with a slight angle of advance by gravity, positioned above the planting area (8) and seedbed area (9).

The picking and dispatch area (11) is positioned in parallel with the area for washing, drying and packaging the fruit (12), which comprises a water channel (24), a drying section (41) and a final section (42) for packaging, positioned in a continuous manner on an automatic assembly line, also including various distribution lines (15) designed for the dispatch of the fruit.

The washing area (13) for the production bars (7) supports (25) and seed trays (18) comprises an automatic water sprinkler system for cleaning and sterilisation.

1. Procedure for continuously growing an aeroponic crop, characterised in that it comprises the following phases:
Phase involving the preparation of the seeding area, positioning on the line and germination.
Phase involving transfer and positioning on production bars.
Phase involving distribution by level and row, vegetative growth and maturing.
Phase involving irrigation and inspection.
Phase involving guiding, transport of production bars and harvesting.
Phase involving the cleaning and preparation of production bars and seed trays.
These phases initially take place on the bottom floor (1) and during maturing on one or more successive floors (1.1) of a modular structure positioned above the ground or beneath it.

2. Procedure for continuously growing an aeroponic crop, according to claim 1, characterised in that in the phase involving the preparation of the seeding area, positioning on the line and germination, the seeds (16) and the substrate (17) are collected and placed in a planting area (8), with, first of all, the substrate (17) and then the seeds (16) being deposited in the corresponding cavities of the seed trays (18), the first irrigation being conducted, with the growing units (20) being created as a result, and the seed trays (18) then being positioned in a seedbed area (9), planted as a continuous line, with their advance, by gravity, corresponding to one position per day, in accordance with their width dimensions, with the necessary days being allowed for the germination and development of the growing units (20), with plants being obtained every day at the end of the germination cycle, while the growing units (20) increase in number in order to make up for defects in certain specimens that do not complete the germination and growth process satisfactorily.

3. Procedure for continuously growing an aeroponic crop, according to claim 2, characterised in that the substrate (17) used is a processed inorganic substrate.

4. Procedure for continuously growing an aeroponic crop, according to claim 1, characterised in that in the phase involving the transfer and positioning of production bars, the growing units (20) are removed from the seed trays (18) and repositioned in the internal cavity of a support (25) designed to be positioned on the production bars (7) for their subsequent development, with the positioning and fixing tasks being carried out, the growing unit (20) being positioned vertically, with the result that as it develops, it extends beyond the height of the support (25), continuing to grow downwards, then, after the position of the support (25) has been fixed on the production bar (7), by means of a pipe section (29), a funnel (31) is placed on it, being designed to ensure that all the irrigation water is used, with the crop then being transferred all along the modular structure, with the result that once the growing units (20) have been loaded on the production bars (7), they are placed by means of a lift (21) one by one at the start of the line in a waiting area (10), moving forward by gravity by one position per day until they are positioned with a lifting/lowering system (22).

5. Procedure for continuously growing an aeroponic crop, according to claim 1, characterised in that in the phase involving distribution by level and row, vegetative growth and maturing, each of the production bars (7) located in the waiting area (10) advances by gravity by one position per day, until being positioned with a lifting/lowering system (22), auger or commercial stacker crane, located at each end of the modular structure, for their transport to the corresponding successive floor (1.1), with the production bars (7) being positioned until daily production is completed, the growing units (20) continuing in their development, flowering and maturing of the fruit, with the production bars (7) advancing by means of the rail system (4), at a rate of one position per day, along the entire length of the modular structure, during the days for which the process lasts.

6. Procedure for continuously growing an aeroponic crop, according to claim 1, characterised in that in the phase involving irrigation and inspection, irrigation is carried out automatically by means of an irrigation controller, with a moisture controller being optionally included at various points of the modular structure for its control, with the leaching of the irrigation water of the growing units (20), being channelled from the production bars (7), through the pipe sections (29) of the supports (25) and its own internal pipes, towards a channel (23) incorporated in the modular structure, carrying the water for its re-use, with the production process being checked by means of a latticework structure (32) with an inspection platform (5) that, operated electronically, passes with a moving motion along the modular structure, through aisles (1.2) formed on both sides so that the operator can inspect the status of the growing units (20).

7. Procedure for continuously growing an aeroponic crop according to claim 1, characterised in that in the phase involving the end of guiding, transport of production bars and harvesting, when the cycle has been completed, the production bars (7) corresponding to daily production reach the end of the guides and are moved to the bottom floor (1) by the lifting/lowering system (22) one by one and are positioned in the picking and dispatch area (11) in the order given by said process, with various tasks then being carried out: continuous inspection, selection and picking of the fruit, which is deposited once it is picked in a channel of water (24) for pre-washing, with the selected fruit then being dried, processed, packaged, stored and finally dispatched, immediately followed by the clearing and removal of the waste, it being deposited in suitable containers in order to be dried and then processed in a grinder unit.

8. Procedure for continuously growing an aeroponic crop, according to claim 1, characterised in that in the phase involving the cleaning and preparation of production bars (7) and seed trays (18), once unloaded during harvesting, the supports (25) of the production bars (7) are stacked and transported in trolleys (26) to a washing area (13) of the modular structure, through a trolley transit area (14), and wait for a new load to start the process, with the seed trays (18) also being collected after being emptied, transported to the washing area (13) for their cleaning and disinfection, with the production bars (7) being transported to the same washing area (13), guided on rails through a transit area.

9. Modular structure for continuously growing an aeroponic crop described in claim 1, characterised in that it comprises structural elements positioned horizontally (2) and vertically (3), forming a bottom floor (1) and one or more successive floors (1.1), with the horizontal structural elements (2) presenting a slight angle to facilitate continuous production by gravity, on a rail system (4), one rail designed for inspection platforms (5), another for an irrigation system (6) and another for production bars (7), also incorporating two aisles (1.2), one being located on the right side between rows one and two, and the other on the left side between rows three and four, with the two central rows—two and three—being connected, there being housed in each aisle a latticework structure (32), conducted on a guide system (33) inserted into the modular structure itself.

10. Modular structure, according to claim 9, characterised in that the latticework structure (32) comprises two columns, which house between them an inspection platform (5), being disposed in its lower part with two surfaces of similar dimensions, which may be opened out from right to left, the irrigation system (6) being made up of a support composed of a water pipe with a plurality of irrigation nozzles (30) for the solution of water and nutrients, incorporating at its ends a track system (27), that is automatically operated so that it may be guided on the ends of the production bars (7), the production bars (7) being made up of two side sections (34) disposed at both ends with a rolling system (35), being connected to each other by two transverse pipes (36) separated from each other and centred at an equidistant distance, disposed with cavities (37) for the insertion of supports (25) fixed by means of a pipe section (29), with the transverse pipes (36) incorporating an internal channel (28) designed to collect the water from the leaching and channel it for its re-use towards a channel (23) positioned on the modular structure, the length dimensions of the production bars (7) corresponding with the dimensions between vertical structural elements (3), the support (25) being made up of an internal cavity and of two side extensions located in its lower part, for positioning on the transverse pipes (36).

11. Modular structure, according to claim 9, characterised in that the bottom floor (1) comprises a planting area (8), seedbed area (9), waiting area (10), picking and dispatch area (11), a washing drying and packaging area (12), an area (13) for washing the production bars (7), supports (25) and seed trays (18) and a trolley transit area (14), delimited for the development of the procedure.

12. Modular structure, according to claim 9, characterised in that the planting area (8) and the seedbed area (9) are comprised and connected to each other by means of an assembly line (38) positioned on a bench—moved forward by gravity—of seed trays (18), which are made up of a perforated plate provided with a plurality of cavities (19), incorporating in their rear part a drainage outlet (40) for the removal of the excess irrigation water, its width dimensions corresponding with the daily advance coinciding with the germination time.

13. Modular structure, according to claim 9, characterised in that the waiting area (10) comprises a continuous line (39) with rails, configured with a slight angle of advance by gravity, positioned above the planting area (8) and seedbed area (9).

14. Modular structure, according to claim 9, characterised in that the picking and dispatch area (11) is positioned in parallel with the area for washing, drying and packaging the fruit (12), which comprises a water channel (24), a drying section (41) and a final section (42) for packaging, positioned in a continuous manner on an automatic assembly line, also including various distribution lines (15).

15. Modular structure, according to claim 9, characterised in that the area (13) for washing production bars (7), supports (25) and seed trays (18) comprises an automatic water sprinkler system for cleaning and sterilisation.
